(19) United States
(12) Patent Application Publication
(10) Pub. No.: US 2019/0233187 A1
(43) Pub. Date: Aug. 1, 2019

(54) ENVIRONMENT PROTECTION BOTTLE CONTAINER

(71) Applicant: Bo-Lian Chen, Taipei (TW)

(72) Inventor: Bo-Lian Chen, Taipei (TW)

(21) Appl. No.: 15/880,549

(22) Filed: Jan. 26, 2018

(51) Int. Cl. B65D 65/46; B65D 23/02; B65D 5/72; B05B 11/00; B65D 5/56

(52) U.S. Cl. CPC B65D 65/466; B65D 23/02; B05B 11/30; B05B 11/0037; B65D 5/563; B65D 5/72

(57) ABSTRACT

An environment protection bottle container includes a container main body and an output main body. The container main body includes a substrate layer and at least one anti-seepage paint layer. The container main body is formed with a top face, a bottom face and a peripheral face, which together define a receiving space. Two ends of the peripheral face are respectively connected with the top and the bottom faces. The top face has a reception section. The output main body is disposed on the reception section. The output main body has a support section in abutment with the top face. The container main body is easy to decompose in natural environment so that the destruction to the environment is reduced. In addition, the output main body is securely and replaceably connected with the container main body so that the output main body is reusable to reduce the waste material.

### BACKGROUND OF THE INVENTION

### 1. Field of the Invention

The present invention relates generally to an environment protection container, and more particularly to an environment protection bottle container, in which the container main body is easy to decompose in natural environment so that the destruction to the environment is reduced.

In addition, the output main body of the environment protection bottle container is conveniently and replaceably assembled with the container main body so that the output main body is reusable to reduce the waste material.

### 2. Description of the Related Art

Currently, the detergent (such as bath cream, shampoo or dish detergent) is generally contained in a plastic-made container. After the detergent in the container is exhausted, the container is often discarded. However, the plastic-made container itself will not decompose in the natural environment so that the plastic-made container must be recovered for reuse in a specific manner.

After the recovered, the plastic-made container must be processed such as chopped, cleaned and classified to form fine plastic granules. Then the plastic granules are reheated to manufacture new plastic-made containers (secondary plastic-made containers). In the above processes, a great amount of water and power is cost. Therefore, to the grand environment, it costs a considerably great resource to recover the plastic-made containers.

In case the plastic-made containers are not recovered, but are burned, a great amount of toxic and stinky gas will be produced. In case the plastic-made containers are buried, a large area of ground will be wasted (the plastic material itself will not decompose in the natural environment). In case the plastic-made containers are discarded in the ocean, the plastic-made containers will become ocean garbage and the ocean creatures may eat the plastic-made containers by mistake to cause death.

It is therefore tried by the applicant to provide an environment protection bottle container to solve the above problems existing in the conventional plastic containers.

### SUMMARY OF THE INVENTION

It is therefore a primary object of the present invention to provide an environment protection bottle container, which can decompose in natural environment so that the destruction to the environment is reduced.

It is a further object of the present invention to provide the above environment protection bottle container, in which the output main body is conveniently and replaceably assembled with the container main body so that the output main body is reusable to reduce the waste material.

To achieve the above and other objects, the environment protection bottle container of the present invention includes a container main body and an output main body. The container main body includes a substrate layer and at least one anti-seepage paint layer. The container main body is formed with a top face, a bottom face and a peripheral face, which together define a receiving space. Two ends of the peripheral face are respectively connected with the top face and the bottom face. The top face has a reception section. The output main body is disposed on the reception section. The output main body has a support section in abutment with the top face.

In the above environment protection bottle container, the output main body further has a nozzle and a straw. The nozzle is disposed on a first face of the support section. The straw is disposed on a second face of the support section and mated with the nozzle. The straw passes through the reception section into the receiving space.

In the above environment protection bottle container, the output main body further has at least one extension plate formed on one side of the support section. The extension plate abuts against the peripheral face.

In the above environment protection bottle container, the extension plate is normal to the support section to form an L-shaped configuration.

In the above environment protection bottle container, an adhesive layer is disposed on one face of the extension plate to connect the extension plate with the peripheral face.

In the above environment protection bottle container, the reception section is equipped with a threaded connector, whereby the nozzle is screwed on the threaded connector of the reception section.

In the above environment protection bottle container, the substrate layer forms the container main body and the anti-seepage paint layer is disposed on an inner surface of the container main body.

In the above environment protection bottle container, the substrate layer is made of paper, while the anti-seepage paint layer is made of aluminum foil adhesive.

In the above environment protection bottle container, a sealing membrane is disposed on the top face to seal the reception section.

In the above environment protection bottle container, the top face is in the form of a plane face.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective exploded view of a first embodiment of the present invention;

FIG. 1B is a perspective assembled view of the first embodiment of the present invention;

FIG. 1C is a sectional assembled view of the first embodiment of the present invention;

FIG. 1D is an enlarged view of circled area of FIG. 1C;

FIG. 2A is a perspective assembled view of a second embodiment of the present invention;

FIG. 2B is a sectional assembled view of the second embodiment of the present invention;

FIG. 3A is a perspective exploded view of a third embodiment of the present invention;

FIG. 3B is a perspective assembled view of the third embodiment of the present invention;

FIG. 3C is a sectional assembled view of the third embodiment of the present invention;

FIG. 4A is a perspective exploded view of a fourth embodiment of the present invention;

FIG. 4B is a perspective assembled view of the fourth embodiment of the present invention; and

FIG. 4C is a perspective view showing the use of the fourth embodiment of the present invention.

### DETAILED DESCRIPTION OF THE PREFERRED EMBODIMENTS

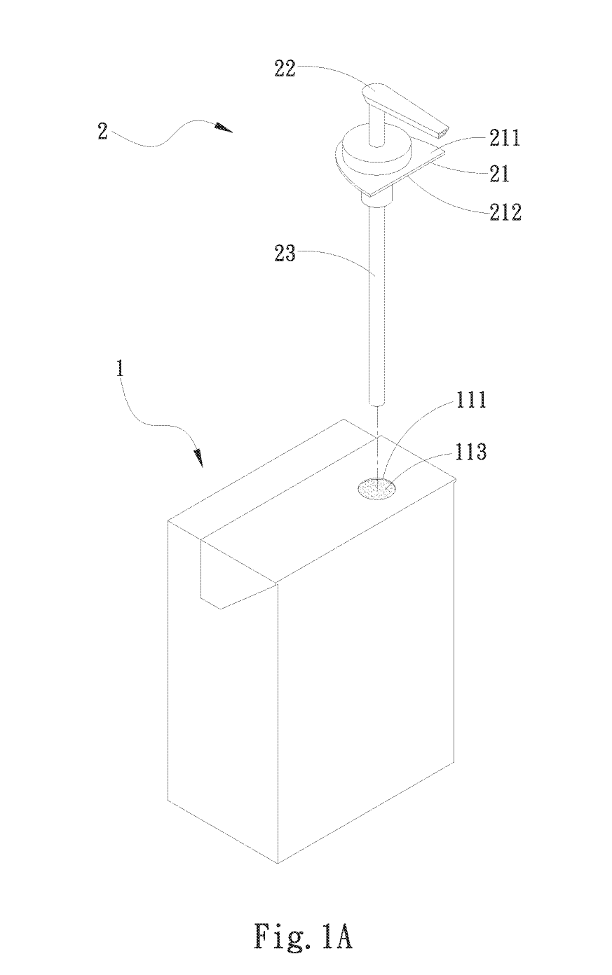

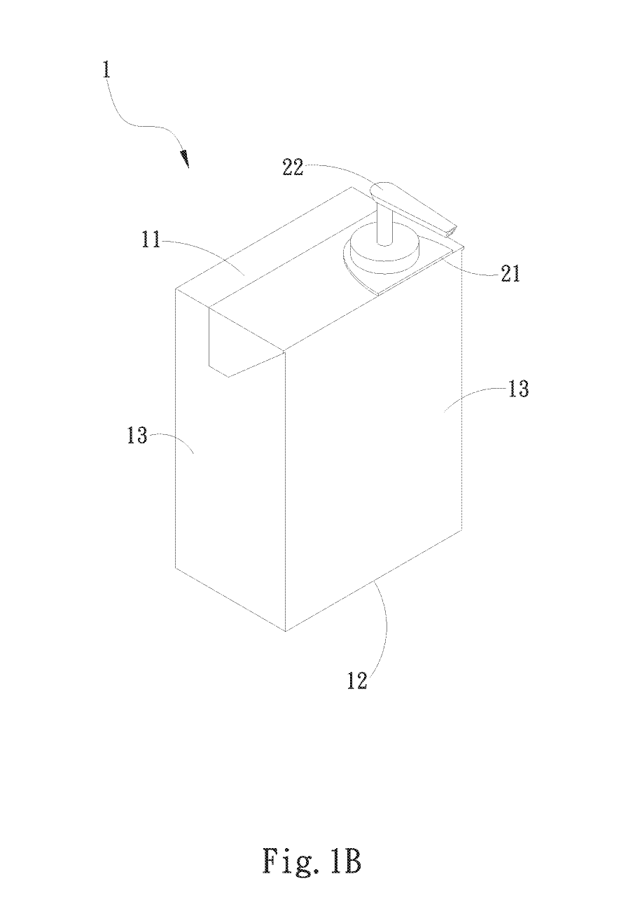

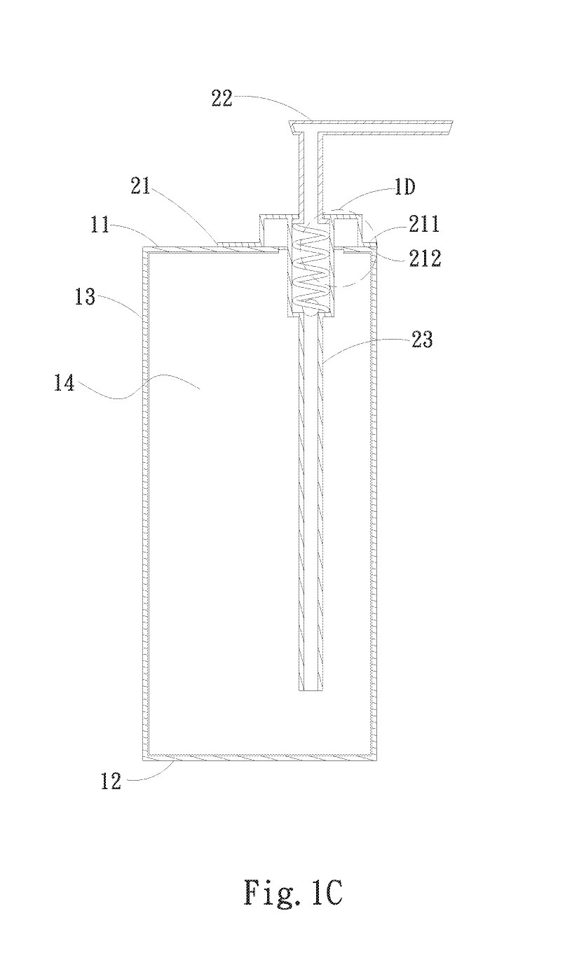

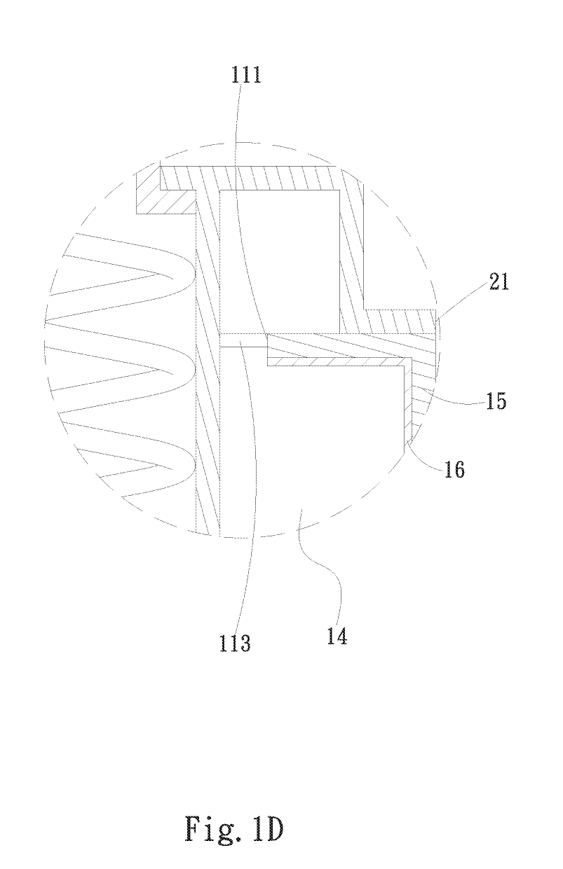

Please refer to FIGS. 1A, 1B, 1C and 1D. FIG. 1A is a perspective exploded view of a first embodiment of the present invention. FIG. 1B is a perspective assembled view of the first embodiment of the present invention. FIG. 1C is a sectional assembled view of the first embodiment of the present invention. FIG. 1D is an enlarged view of circled area of FIG. 1C. According to the first embodiment, the present invention is mainly composed of a container main body 1 and an output main body 2. The output main body 2 is partially inserted into the container main body 1. By means of vacuum sucking, the output main body 2 serves to suck out a liquid such as a detergent from the container main body 1 for use.

The main structure of the container main body 1 includes a substrate layer 15 and at least one anti-seepage paint layer 16. The substrate layer 25 can be made of paper. The anti-seepage paint layer 16 can be made of aluminum foil adhesive. The container main body 1 is formed as a cuboidal box by means of bending. The container main body 1 has a top face 11, a bottom face 12 and a peripheral face 13. The top face 11 and the bottom face 12 are positioned at the upper and lower ends of the container main body 1. The peripheral face 13 is connected between the top face 11 and the bottom face 12. The top face 11, the bottom face 12 and the peripheral face 13 together define a receiving space 14. The anti-seepage paint layer 16 is disposed on an inner surface of the container main body 1. In addition, a waterproof paint layer can be printed on or bonded with an outer surface of the substrate layer 15 to achieve waterproof and anti-seepage effect.

The top face 11 is in the form of a plane face. The top face 11 has a reception section 111. The reception section 111 is a hole. The reception section 111 is sealed with a sealing membrane 113. According to the above structure, the liquid such as a detergent contained in the receiving space 14 will not leak out. The bottom face 12 is in the form of a plane face or a non-plane face, whereby the container main body 1 can be conveniently placed on any site.

The output main body 2 has a support section 21, a nozzle 22 and a straw 23. The support section 21 has a first face 211 and a second face 212. The nozzle 22 is disposed on the first face 211. The straw 23 is disposed on the second face 212. The nozzle 22 is connected with the straw 23. By means of pressing the nozzle 22, a vacuum sucking force is created to suck the liquid. The second face 212 is in the form of a plane face corresponding to the top face 11.

In use, the straw 23 of the output main body 2 is aimed at the reception section 111 of the container main body 1 and then the straw 23 is forced to penetrate through the sealing membrane 113. The second face 212 of the support section 21 is attached to and in contact with the top face 11 of the container main body 1 to complete the assembly of the container main body 1 and the output main body 2. By means of pressing down the nozzle 22, the liquid in the receiving space 14 can be sucked and ejected out.

When pressing the nozzle 22, the second face 212 contacts the top face 11 by a large area. Therefore, the top face 11 will not be over-pressurized at one single point so that the top face 11 is prevented from being deformed. In addition, a reusable adhesive layer can be disposed between the second face 212 and the top face 11 to enhance the fixing effect between the container main body 1 and the output main body 2.

As shown in the drawings, in this embodiment, the reception section 111 has a diameter slightly larger than a diameter of the straw 23. In this case, the straw 23 can be conveniently inserted into the container main body 1. Alternatively, the diameter of the reception section 111 can be just equal to the diameter of the straw 23. Under such circumstance, the reception section 111 can more securely hold the straw 23.

After used, the output main body 2 is extracted out of the original container main body 1 (the detergent is exhausted). The output main body 2 is reusable, that is, the output main body 2 can be connected with another new container main body 1. Accordingly, the waste material can be reduced to minify the contamination and destruction to natural environment.

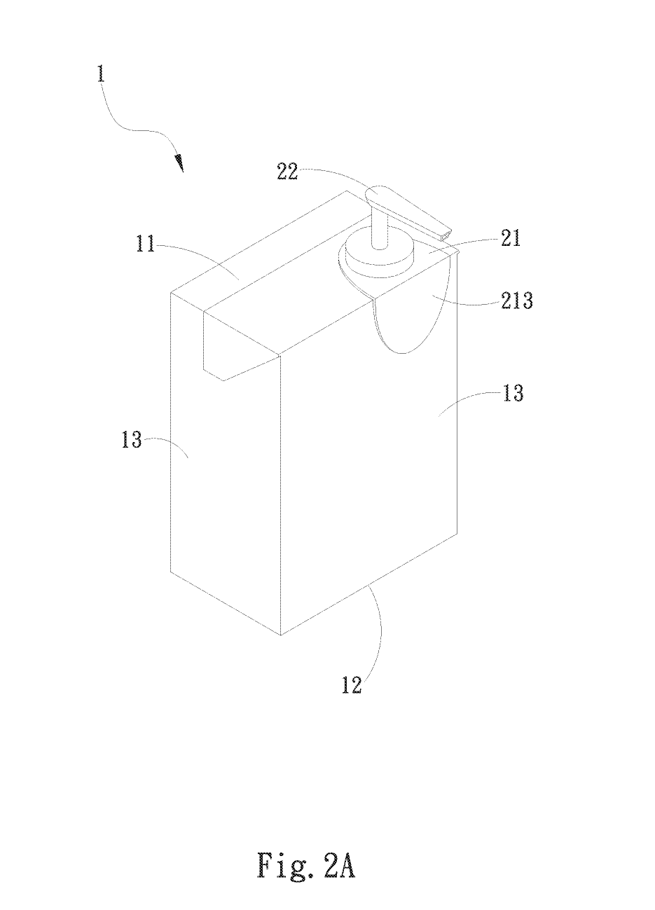

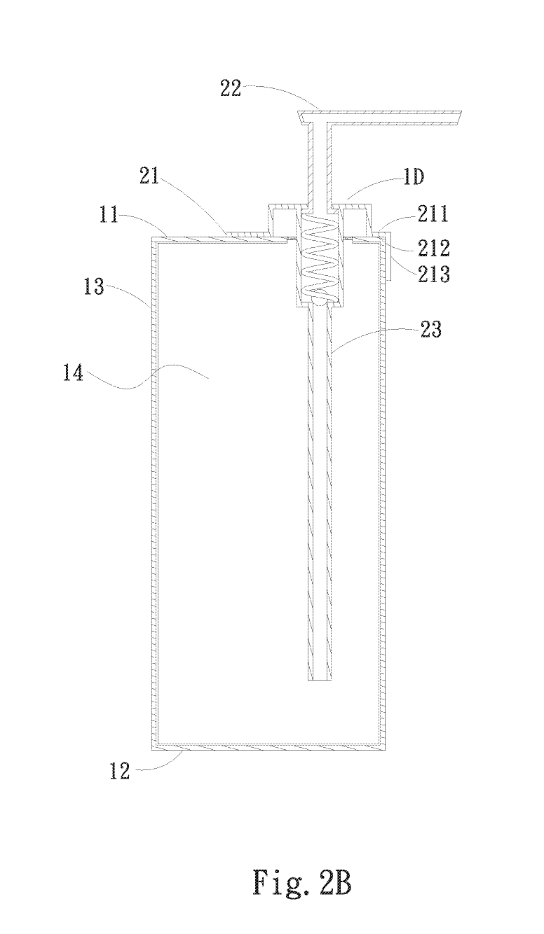

Please now refer to FIGS. 2A and 2B. FIG. 2A is a perspective assembled view of a second embodiment of the present invention. FIG. 2B is a sectional assembled view of the second embodiment of the present invention. Also referring to FIGS. 1A to 1D, the second embodiment is partially identical to the first embodiment and thus will not be redundantly described hereinafter. The second embodiment is different from the first embodiment in that the output main body 2 further has an extension plate 213 extending from the support section 21. The extension plate 213 is normal to the support section 21 to form an L-shaped configuration. The extension plate 213 abuts against the peripheral face 13. In addition, a reusable adhesive layer can be disposed on the extension plate 213 to enhance the fixing effect between the container main body 1 and the output main body 2.

The usage and assembling process of the second embodiment are substantially identical to the first embodiment and thus the usage and replacement operation manner of the second embodiment will not be redundantly described hereinafter. The second embodiment is different from the first embodiment in that when detaching the output main body 2, a force is first applied to separate the extension plate 213 from the peripheral face 13. Then the output main body 2 is upward extracted out of the container main body 1. When connecting the output main body 2 with the container main body 1, the operation is reversed. The output main body 2 is first downward inserted into the container main body 1 and then a force is applied to connect the extension plate 213 with the peripheral face 13.

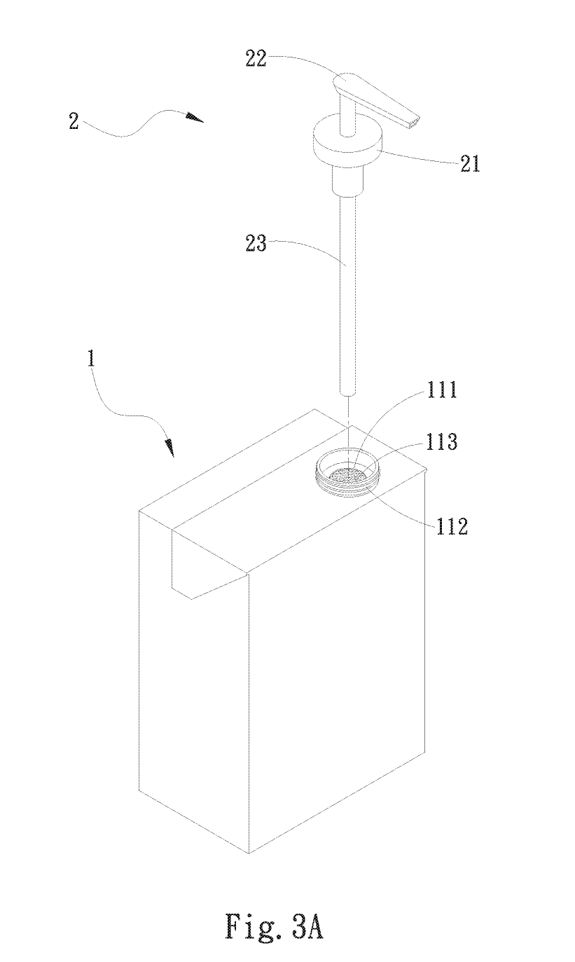

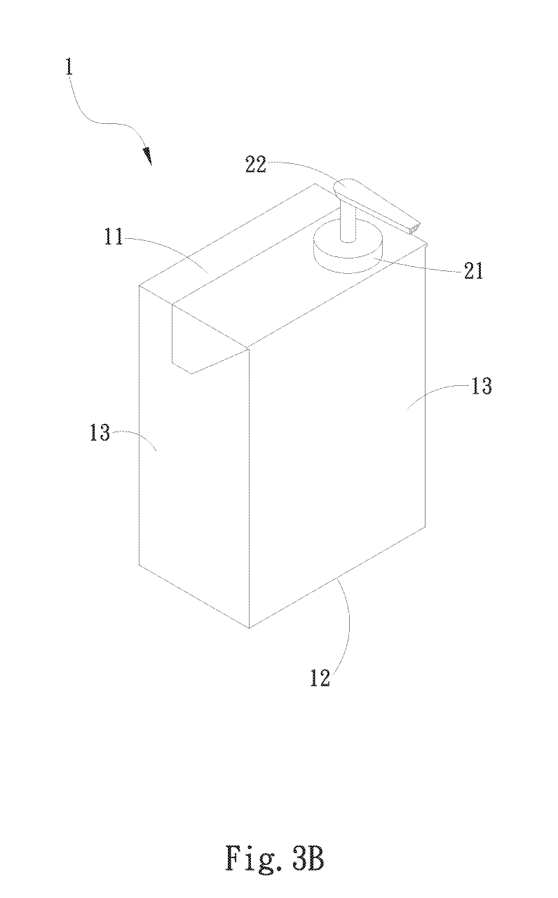

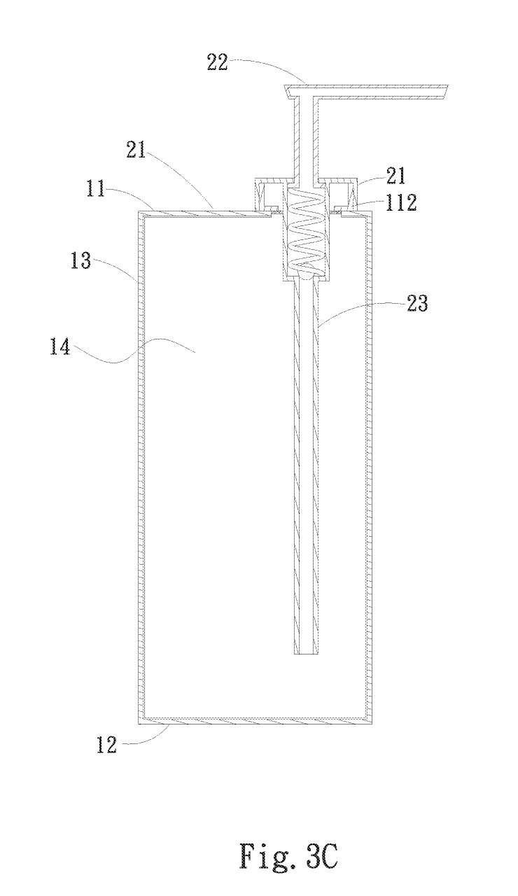

Please now refer to FIGS. 3A, 3B and 3C. FIG. 3A is a perspective exploded view of a third embodiment of the present invention. FIG. 3B is a perspective assembled view of the third embodiment of the present invention. FIG. 3C is a sectional assembled view of the third embodiment of the present invention. Also referring to FIGS. 1A to 1D, the third embodiment is partially identical to the first embodiment and thus will not be redundantly described hereinafter. The third embodiment is different from the first embodiment in that the reception section 111 is further equipped with a threaded connector 112 and the inner wall of the nozzle 22 is formed with a thread corresponding to the threaded connector 112. Accordingly, the nozzle 22 is screwed on the reception section 111 to connect the output main body 2 with the container main body 1.

The usage of the third embodiment is substantially identical to the first embodiment and thus the usage and replacement operation manner of the third embodiment will not be redundantly described hereinafter. The third embodiment is different from the first embodiment in that when inserting the output main body 2 into the container main body 1 to the bottom, the nozzle 22 is screwed on the reception section 111. Reversely, when detaching the output main body 2 into the container main body 1, the nozzle 22 is unscrewed from the reception section 111.

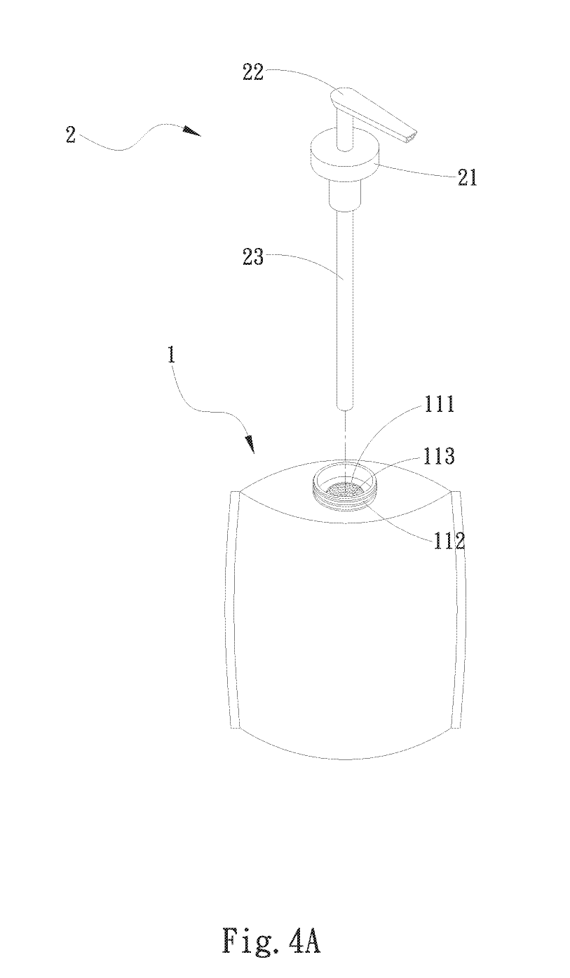

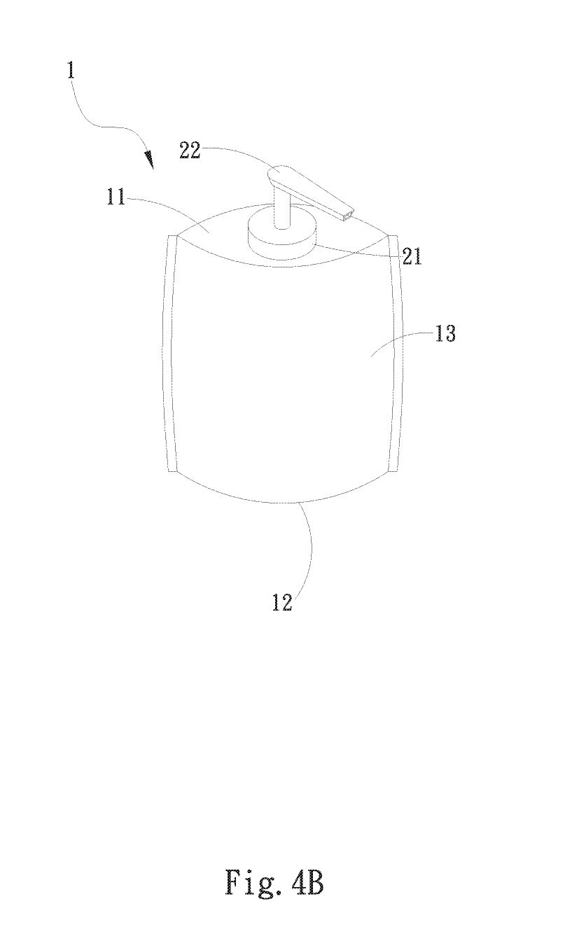

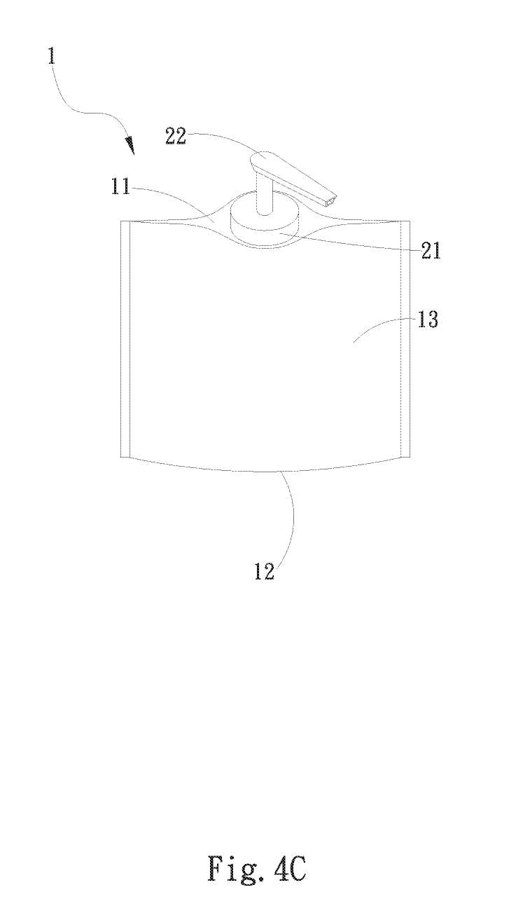

Please now refer to FIGS. 4A, 4B and 4C. FIG. 4A is a perspective exploded view of a fourth embodiment of the present invention. FIG. 4B is a perspective assembled view of the fourth embodiment of the present invention. FIG. 4C is a perspective view showing the use of the fourth embodiment of the present invention. Also referring to FIGS. 3A to 3C, the fourth embodiment is partially identical to the third embodiment and thus will not be redundantly described hereinafter. The fourth embodiment is different from the third embodiment in that the container main body 1 is made of a soft material and has a configuration other than a cuboidal box.

The usage of the fourth embodiment is substantially identical to the third embodiment and thus the usage and replacement operation manner of the fourth embodiment will not be redundantly described hereinafter. The fourth embodiment is different from the third embodiment in that when the output main body 2 continuously sucks out the detergent in the container main body 1, the interior of the container main body 1 will be gradually vacuumed to gradually flatten the container main body 1. When the liquid is exhausted, the container main body 1 is flattened as shown in FIG. 4C. Accordingly, the container main body 1 has the advantage that the volume will be gradually minified.

In any of the above embodiments, after used, the container main body 1 can be easily flattened to minify the total volume. Moreover, the material (paper and aluminum foil adhesive) of the container main body 1 will decompose itself in the natural environment so that the container main body 1 can be directly buried without any special treatment. Therefore, the container main body 1 can be easily recovered to reduce the destruction to the natural environment.

In conclusion, in comparison with the conventional plastic container, the present invention has the following advantages:
1. The material of the container main body can decompose itself in the natural environment so that the destruction to the environment is reduced.
2. It is easier to recover the container main body so that the recovery cost is lowered.
3. The material of the container main body can be hydrolyzed.
4. It is unnecessary to discard the entire container.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

1: An environment protection bottle container comprising:
a container main body including a substrate layer and at least one anti-seepage paint layer, the container main body being formed with a top face, a bottom face and a peripheral face, the top face, the bottom face and the peripheral face together defining a receiving space, two ends of the peripheral face being respectively connected with the top face and the bottom face, the top face having a reception section; and
an output main body disposed on the reception section, the output main body having a support section in abutment with the top face; and
wherein the output main body further has a nozzle and a straw, the nozzle being disposed on a first face of the support section, the straw being disposed on a second face of the support section and mated with the nozzle, the straw passing through the reception section into the receiving space; wherein the container main body is made of a soft material and has a configuration other than a cuboidal box; and wherein the container main body is gradually flattened when an interior of the container main body is gradually vacuumed.

2. (canceled)

3: The environment protection bottle container as claimed in claim 1, wherein the output main body further has at least one extension plate formed on one side of the support section, the extension plate abutting against the peripheral face.

4: The environment protection bottle container as claimed in claim 3, wherein the extension plate is normal to the support section to form an L-shaped configuration.

5: The environment protection bottle container as claimed in claim 3, wherein an adhesive layer is disposed on one face of the extension plate to connect the extension plate with the peripheral face.

6: The environment protection bottle container as claimed in claim 1, wherein the reception section is equipped with a threaded connector, whereby the nozzle is screwed on the threaded connector of the reception section.

7: The environment protection bottle container as claimed in claim 1, wherein the substrate layer forms the container main body and the anti-seepage paint layer is disposed on an inner surface of the container main body.

8: The environment protection bottle container as claimed in claim 1, wherein the substrate layer is made of paper, while the anti-seepage paint layer is made of aluminum foil adhesive.

9: The environment protection bottle container as claimed in claim 1, wherein a sealing membrane is disposed on the top face to seal the reception section.

10: The environment protection bottle container as claimed in claim 1, wherein the top face is in the form of a plane face.
